(19) United States
(12) Patent Application Publication
(10) Pub. No.: US 2010/0269232 A1
(43) Pub. Date: Oct. 21, 2010

(54) Scanning Probe Microscope that Outputs Metadata with Image

(76) Inventor: Richard Kenton Workman, Sunnyvale, CA (US)

Correspondence Address: Agilent Technologies, Inc. in care of:;CPA Global, P. O. Box 52050, Minneapolis, MN, 55402, US

(21) Appl. No.: 12/425,587

(22) Filed: Apr. 17, 2009

(51) Int. Cl. G12B 21/08

(52) U.S. Cl. 850/33

(57) ABSTRACT

A scanning probe microscope and method for using the same are disclosed. The scanning probe microscope includes a probe mount, a probe position signal generator, and a controller. The probe mount is adapted to receive a probe having a tip that moves in response to an interaction between the tip and a local characteristic of a sample. The probe position signal generator generates a position signal indicative of a position of the probe tip. The controller receives the position signal and derives a pixel value for a corresponding location on the sample from the position signal over a pixel time period. The controller generates an image that includes the pixel value. The controller stores a plurality of intermediate pixel data values at different times during the pixel time period.

### BACKGROUND OF THE INVENTION

Scanning probe microscopes are a class of imaging techniques in which a tip that interacts locally with a sample is scanned over the surface of the sample to generate a three-dimensional image representing a property of the surface at different points on the surface of the sample. For example, in atomic force microscopy, the surface interaction force between the probe tip and the sample is measured at each point on the sample. The tip has a very small end and is mounted on the end of a cantilevered arm. The other end of the cantilevered arm is attached to a cantilevered arm mounting structure. The height of this structure relative to the sample can be altered either by moving the structure or the sample depending on the particular microscope design.

As the tip is moved over the surface of the sample, the arm deflects in response to the changes in topography of the surface. The deflection of the arm is measured and used to control the actuator that sets the distance between the cantilevered arm mounting structure and the sample. Images are typically acquired in one of two modes. In the contact or constant force mode, the tip is brought into contact with the sample and the tip moves up and down as the tip is moved over the surface. The deflection of the arm is a direct measure of force and topographical variations. A feedback controller measures the deflection and adjusts the height of the cantilevered arm mounting structure so as to maintain constant force between the cantilevered probe and the surface, i.e., the arm at a fixed deflection. The height of the cantilevered arm's fixed end as a function of the lateral position on the sample is used to construct the final image of the sample's surface.

The applications of the contact mode are limited due to a strong shear force developed whilst the tip is moved over the sample surface while staying in constant contact with the sample surface. A second mode that avoids these shear forces is often referred to as AC mode. In the AC, or non-contact mode, the tip and arm are oscillated at a frequency near the resonant frequency of the arm. The height of the tip is controlled such that the tip either avoids contact with the surface or makes only a light intermediate contact over part of the oscillation cycle. In this mode, the tip samples short-range tip/sample forces. Alterations in the oscillation amplitude from the short range forces between the tip and the sample result in changes in the oscillations of the cantilever arm. A detector measures a property that is related to the tip position and generates a signal that is likewise related to the position of the tip. This signal will be referred to as the tip position signal in the following discussion. For example, the position of a spot of light on an imaging detector that results from a light beam that is reflected from a mirrored surface on the cantilevered arm is used in some scanning probe microscopes to provide the tip position signal.

The controller adjusts the height of the cantilevered arm over the sample such that the oscillation amplitude, phase and/or frequency of the tip position signal is kept at a predetermined constant value. Since the tip is not in constant contact with the sample, the shear forces applied to the sample are significantly less than in the contact mode in which the tip is in constant contact. For soft samples, this mode can provide a more accurate image of the surface in its non-disturbed configuration.

It should be noted that the image can be constructed from some other parameter besides the height of the cantilevered arm as a function of position on the sample when the cantilevered arm is positioned to maintain a property of the tip position signal constant. For example, the image can be formed by measuring the amplitude of a harmonic of the tip position signal while the cantilevered arm is maintained at a height that maintains the amplitude of the fundamental frequency of the tip position signal constant.

The image is constructed one point at a time and the rate at which the image is constructed is limited by the rate at which the tip can be moved relative to the sample, as well as the time required for the servo loop to reposition the tip vertically to maintain the distance between the surface and the tip. The feedback control system that is used to position the cantilevered arm vertically over the sample must extract the needed information from the oscillatory signal provided by the system that tracks the position of the tip as a function of time. The time to extract the information is long compared to the period of the tip position signal. Hence, each point in the image represents an average of a property of the tip position signal over a relatively long period of time.

In general, much of the information in the tip position signal is discarded when constructing an image. For example, if an image is based on the amplitude of the first harmonic of the tip position signal, information with respect to the higher harmonics of the tip position signal is discarded. The discarded information could be utilized to provide alternative views of the sample, or a portion thereof. In principle, the user could re-image the sample using one of these harmonics to provide a second view of the sample if the first image suggested that such a second image would yield useful information.

Unfortunately, re-imaging the sample is not always possible for a number of reasons. First, the time needed to form an image is measured in minutes. Over this time frame, the sample can change, and hence, the second image may not provide the needed view. In addition, as noted above, the interaction of the tip with the sample can alter the sample even in the case of the AC modes described above, and hence, the second image would be of a “different” sample. Furthermore, the decision to re-image the sample may be made only after a detailed off-line analysis of the first image, at which time the sample will have changed. Finally, the number of possible secondary images is quite large, since images based on combinations of harmonics or other characteristics of the sample are also possible. Given that each image requires a period of minutes, the time to provide a complete set of images, one image at a time, can be prohibitive even in the case in which the sample is capable of being re-imaged. In addition, if the sample is removed from the microscope prior to the decision to re-image the sample, the problems associated with finding the same area to image again can be prohibitive.

### SUMMARY OF THE INVENTION

The present invention includes a scanning probe microscope and method for using the same. The scanning probe microscope includes a probe mount, a probe position signal generator, and a controller. The probe mount is adapted to receive a probe having a tip that moves in response to an interaction between the tip and a local characteristic of a sample, the probe tip being coupled to the probe mount. The probe position signal generator generates a position signal indicative of a position of the probe tip. The controller receives the position signal and derives a first pixel value for a corresponding first location on the sample from the position signal over a first pixel time period. The controller generates an image of an object in the sample, the image including the pixel value. The controller stores a plurality of intermediate pixel data values at different times during the first pixel time period. The intermediate pixel data values may include values related to the position signal.

The controller also generates a second pixel value for a corresponding second location on the sample from the position signal over a second pixel time period. The image also includes the second pixel value. The controller also stores a plurality of intermediate pixel data values at different times during the second pixel time period.

In one aspect of the invention, the controller stores a time stamp indicative of a time during the first pixel time period with the plurality of intermediate pixel data values. The time stamp can be derived from a clock that is synchronized with an external device separate from the scanning probe microscope. The external device makes measurements related to the sample or otherwise interacts with the sample and stores the data related to those interactions or measurements with a device time stamp that is derived from the clock.

In one embodiment, the plurality of intermediate pixel data values includes values of a Fourier transform of the position signal values during the first pixel time period. In another embodiment, the plurality of intermediate pixel data values includes a position signal frequency and phase shift characterizing the position signal during the first pixel time period. In yet another embodiment, the scanning probe microscope includes a servo that generates a servo signal that is input to an electro-mechanical actuator that sets a distance between the second end of the cantilever arm and the sample. The plurality of intermediate pixel data values includes values of the servo signal during the first pixel time period.

In one aspect of the invention, the controller outputs a data file that includes an image of the sample. The image includes a plurality of image pixel values. Each image pixel value is derived from the position signal over a corresponding pixel time period and corresponding to a different location on the sample. The data file also includes one set of intermediate pixel data values corresponding to each image pixel value in the image. Each set of intermediate pixel data values is related to values of the position signal at different times during the pixel time period corresponding to that image pixel value. Each set of intermediate pixels can also includes a time stamp indicative of a time during which the intermediate pixel values utilized to generate a corresponding one of the image pixels was generated.

### BRIEF DESCRIPTION OF THE DRAWINGS

FIG. 1 illustrates one embodiment of an atomic force microscope according to the present invention.

FIG. 2 illustrates one embodiment of a file format that could be used with the present invention.

FIG. 3 illustrates one possible arrangement for more detailed pixel data.

### DETAILED DESCRIPTION OF PREFERRED EMBODIMENTS OF THE INVENTION

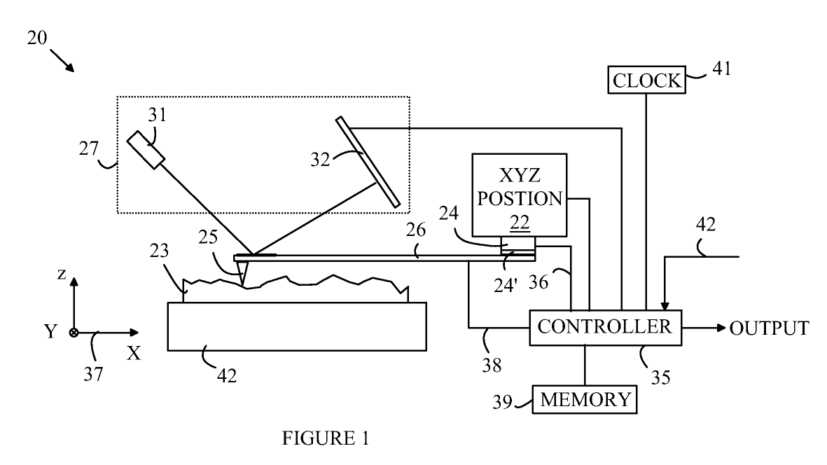

The manner in which the present invention provides its advantages can be more easily understood with reference to FIG. 1, which illustrates one embodiment of an atomic force microscope according to the present invention. Microscope 20 includes a probe assembly and a stage 42 on which a sample 23 to be imaged is mounted. The probe assembly includes a tip 25 that is mounted on a cantilever 26 that deflects in response to forces on probe tip 25. The degree of deflection of cantilever 26 is measured by a detector 27. In the embodiment shown in FIG. 1, the detector 27 includes a light source 31 and a photodetector 32. Light source 31 illuminates a reflector on cantilever 26, and the location of the reflected light is detected by a photodetector that provides a tip position signal that is related to the degree of deflection of cantilever 26.

One end of cantilever 26 is attached to an electro-mechanical actuator such as piezoelectric actuator 22 that can move that end in three dimensions, denoted by x, y, and z as shown at 37. An AC actuator 24 that vibrates the fixed end of cantilever 26 is disposed between actuator 22 and cantilever 26 and receives a signal over line 36 that controls the amplitude of the vibrations. The fixed end of the cantilever arm can be attached to AC actuator 24 by a probe mount 24′. AC actuator 24 can be constructed from lead zirconate titanate (PZT) that is driven by an AC drive signal at a frequency ω₀ by controller 35. Here, ω₀ is chosen to be a frequency that is substantially equal to one of the resonant frequencies of cantilever 26. The signal from photodetector 32 includes an AC component at ωₒ that is the result of this induced vibration. This signal will be referred to as the tip position signal in the following discussion. The amplitude and phase of the tip position signal and its harmonics depend on the interaction between probe tip 25 and sample 23 in the vicinity of probe tip 25, and hence, the amplitude of this signal depends on the distance between tip 25 and the sample. Controller 35 controls the Z-coordinate of the cantilever through actuator 22 to maintain a parameter related to the tip position signal at a predetermined value while the x and y coordinates of the probe tip are varied to provide an image of the sample surface, e.g., the height of the cantilever end as a function of x and y, which is output by controller 35. It should be noted that an image could also be formed utilizing the amplitude or the phase the tip position signal at ωₒ or any of the higher harmonics of this frequency.

The tip position signal in AFM is influenced not only by mechanical tip-sample interactions, but also by long-range forces such as electrostatic forces between the probe and a sample. Because the same cantilever responds to both forces, their contributions need to be separated in some situations. In one of the non-contact modes, this is achieved by operating at two different frequencies. The surface profiling is performed by using the probe oscillating near its resonant frequency while the electric potential is applied to the probe at another frequency ω₁ via conductor 38. Therefore during scanning, which is performed with the feedback operating at the resonant frequency, the cantilever displacements caused by electrostatic forces are monitored with a lock-in amplifier set at the other frequency. In this way the AFM can simultaneously measure the sample topography and a map of electrostatic forces. This operation is the essence of electric force microscopy (EFM). In the related approach, known as Kelvin force microscopy (KFM), an additional DC voltage is applied to the probe and the feedback mechanism adjusts the voltage value to nullify the effect of the tip-sample electrostatic force on the probe. In this way, a map of surface potential is generated simultaneously with the topographical image.

It should be noted that the arrangement shown in FIG. 1 is only one of many possible electro-mechanical configurations. In one class of microscopes, the probe tip is scanned in 3 axes. In another class of microscopes, the sample is scanned in 3 axes while the base of the cantilever arm remains stationary. In yet another class of microscopes, the sample is scanned in some axes and the cantilever arm in others. Accordingly, the arrangement shown in FIG. 1 is for illustrative purposes. However, the present invention applies equally well to all embodiments/designs.

From the above description, it will be apparent that there are a number of other signals and potential levels that can change over the course of acquiring an image in addition to the tip position signal. In the present invention, some or all of this data is recorded in a memory 39 for each of the pixels in the image. This data is labeled such that the data corresponding to each pixel in the image can be retrieved separately for that image. Hence, this data can be reprocessed to form other images after the original image is constructed without re-imaging the sample. Since the reprocessing time is typically much smaller than the original imaging time, different images of the sample can be generated in a time that is much smaller than the time that would be required if the sample were re-imaged. Furthermore, the problems related to changes in the sample between images are substantially reduced.

In one aspect of the present invention, the tip position signal as a function of time during the measurement of each pixel is also recorded with that pixel. To simplify the following discussion, the time over which data is collected to provide one pixel value will be referred to as the pixel dwell time. In the case in which the cantilever is moved to a new (x,y) position and the z-position of the cantilever is adjusted by the servo loop before making the measurement and moving on, the pixel dwell time is literally the time at which the probe tip is over the (x,y) position corresponding to the pixel in question.

In the above embodiment, the tip position signal itself is sampled on a time scale that is small compared to the dwell time at each pixel. As noted above, the dwell time is long compared to the period of the fundamental frequency in the tip position signal. Hence, a number of samples of the tip position signal are digitized during the dwell time and stored with the pixel value or a quantity that is related to the pixel value. To reduce the volume of data associated with each pixel, some form of data compression is advantageous. For example, the tip position signal is expected to be a bandwidth limited signal, and hence, is well represented by a few harmonics in the Fourier transform of the tip position signal. In addition, the amplitudes and phases of these components are expected to vary much more slowly as a function of time, and hence, can be coded by a few parameters that can be interpolated to provide the amplitude and phase of each harmonic of interest as a function of time.

In another aspect of the present invention, the data for each pixel also includes a time stamp that is generated by a clock 41 that is preferably synchronized to an external time standard so that the time stamps can be used to coordinate measurements or treatments provided by other instruments on the same sample during the imaging operation. The information from the other instruments can be recorded separately by those instruments with corresponding time stamps or input to the present invention via a port such as port 42 for inclusion in the information stored for each pixel. In addition, port 42 can be utilized to provide signals that are to be applied to cantilever 26 or to provide an electrical connection to cantilever 26, and hence, tip 25 can be utilized by the external instrument in performing other measurements of the sample.

In one embodiment, the time stamp includes both the starting time and ending time for each pixel measurement to better define the correspondence between the external data and the data acquired by the microscope 20. The time stamp data can also include a series of time stamps between the start and stop values to better define the time at which various signals are measured or other events occur.

A parameter that can change over the course of the image could be monitored and recorded with the data for each pixel. For example, changes in temperature could also be monitored and recorded. The parameters may relate to the pixel being measured or to some other event that occurred at the time the pixel was being measured, but was unrelated to that pixel. For example, the minimum and maximum values of a signal related to the pixel currently being measured could be recorded. In AC mode, the minimum and maximum amplitude or phase of the position signal could be recorded. In contact mode, the minimum and maximum deflection error during the pixel measurement could be recorded. If the user changes some microscope parameter during the scan, the change can be recorded with the data for the current pixel even though the change is not related to the current pixel measurements.

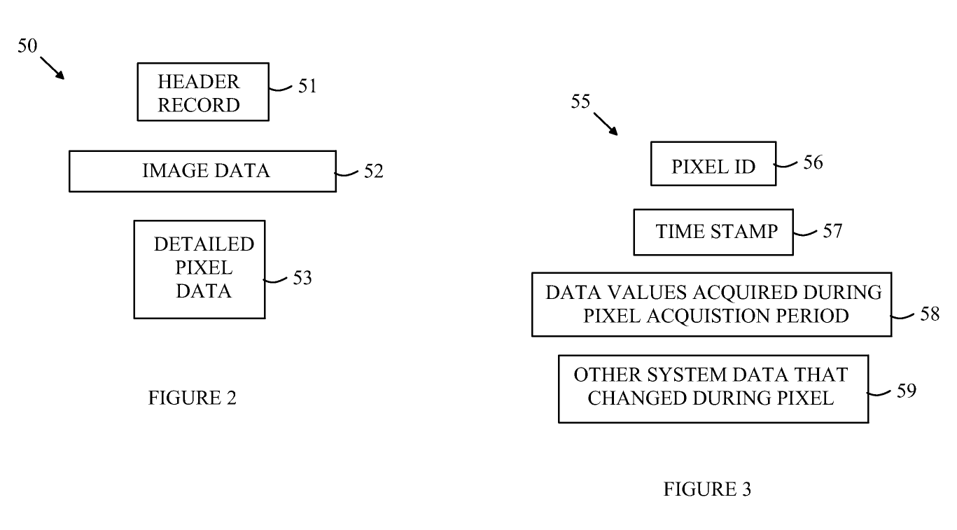

In one embodiment, controller 35 outputs the image data in a file format having the conventional image data in a format utilized by conventional scanning probe microscope image viewing software. Refer now to FIG. 2, which illustrates one embodiment of a file format that could be used with the present invention. File 50 includes a header record 51 that contains the information that specifies the conditions under which the image was generated as well as other information that specifies the imaging conditions that remained constant over the course of the imaging operation. The conventional image data 52 follows the header data in one of the conventional image formats. The formatting of records 51 and 52 is chosen such that the file can be read and displayed using a conventional scanning probe microscope software package that does not provide the capabilities of using the more detailed information of the present invention. Hence, a file according to one aspect of the present invention is backward compatible with existing scanning probe microscope processing software.

The more detailed pixel data consisting of the extra data for each pixel is appended to this file as a series of records 53. Refer now to FIG. 3, which illustrates one possible arrangement for this extra data. In the embodiment shown in FIG. 3, there is one record 55 for each pixel in the conventional image. Each augmented data record 55 includes data 56 identifying the corresponding pixel in the conventional image 52. The data can reference the specific pixel by location or any other method that identifies the pixel in question. Each augmented data record 55 optionally includes a time stamp 57, which identifies the times at which the pixel data in image 52 was accumulated. For example, the time stamp can include start and stop times for the pixel. In some cases, the start time is sufficient, since the stop time could be inferred from the start time of the next pixel. As noted above, in one embodiment, the time stamps are generated by a clock that is synchronized to a common time standard that can be used to match data taken by other instruments to the data taken by the scanning probe microscope.

The augmented data records include various measured data values 58 that were acquired during the period specified by time stamp 57. As noted above, these values could include raw data values generated from the tip position signal or other data derived from the tip position signal such as data related to the Fourier transform of the tip position signal. The data can be stored in its raw form or in any appropriate data compression scheme. For example, the tip position signal can be coded as a frequency and phase offset. Since the frequency changes slowly, the frequency data is easily compressed. The phase changes in regions of change in the topography of the sample, and hence, is also easily compressed. The data values can include any measurements that were made during the time the pixel identified by pixel ID 56 was being measured. For example, the data could also be generated by other measurements of parameters in the scanning probe microscope or by parameters measured by instrumentation that is external to the scanning probe microscope mechanism, or the scanning probe microscope itself. As noted above, such information can be received by controller 35 on an external port or generated by controller 35 from other connections to controller 35. The augmented data could also include data such as the feedback control signal used to set the height of the fixed end of the cantilever arm.

Finally, each record can also include data 59 that records events or parameters that changed during the course of the corresponding pixel data accumulation. This data differs from the data values 58 discussed above in that the parameters are not necessarily measured at each pixel and recorded, but rather are events that happened to occur during the measurement of that pixel. For example, controller 59 could receive an interrupt indicating that a condition of interest occurred during the measurement of the pixel in question. In another example, controller 59 would regularly measure some parameter such as the temperature of the sample; however, since that data changes only rarely, controller 59 would only include the measurements when the data changed significantly from the values specified in a previous pixel's data or the value indicated in header record 51.

In the above-described embodiments, there is one conventional image that is measured during the time the pixel data is acquired. However, embodiments in which there is a plurality of image channels, each channel generating one conventional image could also be constructed. In this case, it is assumed that each conventional image includes pixels measured at the same location on the sample. The additional data is then accumulated over the time periods corresponding to that location on the sample.

The above-described embodiments of the present invention have utilized a scanning probe microscope in which the tip that interacts with the sample is mounted on a cantilevered arm. However, the present invention can also be applied to forms of scanning probe microscope that do not utilize the cantilevered arm system. In general, a scanning probe microscope can be viewed as a local probe that is scanned over the surface of the sample with some property being measured at each point on the sample. For example, a scanning probe microscope called a scanning tunneling microscope uses a conductive probe tip to measure a tunneling current between the conductive tip and a conductive sample. With a constant applied voltage, the servo loop adjusts the tip-sample separation to maintain a constant tunneling current. The vertical position of the probe can then be used to generate an image of the surface of the sample.

The above-described embodiments of the present invention have been provided to illustrate various aspects of the invention. However, it is to be understood that different aspects of the present invention that are shown in different specific embodiments can be combined to provide other embodiments of the present invention. In addition, various modifications to the present invention will become apparent from the foregoing description and accompanying drawings. Accordingly, the present invention is to be limited solely by the scope of the following claims.

What is claimed is:

1. A scanning probe microscope comprising:
a probe mount adapted to receive a probe having a tip that moves in response to an interaction between said tip and a local characteristic of a sample, said probe tip being coupled to said probe mount;
a probe position signal generator that generates a position signal indicative of a position of said probe tip;
a controller that receives said position signal and derives a first pixel value for a corresponding first location on said sample from said position signal over a first pixel time period, said controller generating an image of an object in said sample, said image comprises said pixel value, wherein said controller stores a plurality of intermediate pixel data values at different times during said first pixel time period.

2. The scanning probe microscope of claim 1 wherein said intermediate pixel data values comprise values related to values of said position signal at different times during said first pixel time period.

3. The scanning probe microscope of claim 1 wherein said probe tip is mounted on a first end of a cantilever arm, a second end of said cantilever arm being coupled to said probe mount.

4. The scanning probe microscope of claim 1 wherein said controller generates a second pixel value for a corresponding second location on said sample from said position signal over a second pixel time period, said image comprising said second pixel value, wherein said controller stores a plurality of intermediate pixel data values at different times during said second pixel time period.

5. The scanning probe microscope of claim 1 wherein said controller stores a time stamp indicative of a time during said first pixel time period with said plurality of intermediate pixel data values.

6. The scanning probe microscope of claim 5 wherein said time stamp is derived from a clock that is synchronized with an external device separate from said scanning probe microscope, said external device making measurements related to said sample and storing said measurements with a device time stamp that is derived from said clock.

7. The scanning probe microscope of claim 5 wherein said plurality of intermediate pixel data values comprises values of a Fourier transform of said position signal values during said first pixel time period or a position signal frequency and phase shift characterizing said position signal during said first pixel time period.

8. The scanning probe microscope of claim 3 wherein said second end of said cantilever arm is vibrated at an excitation frequency and wherein said position signal frequency is related to said excitation frequency.

9. The scanning probe microscope of claim 1 further comprising a servo that generates a servo signal that is input to an electro-mechanical actuator that sets a distance between said probe tip and said sample, and wherein said plurality of intermediate pixel data values comprises values of said servo signal during said first pixel time period.

10. The scanning probe microscope of claim 1 wherein said controller outputs a data file comprising an image of said sample that comprises a plurality of image pixel values, each image pixel value being derived from said position signal over a corresponding pixel time period and corresponding to a different location on said sample, said data file further comprising one set of intermediate pixel data values corresponding to each image pixel value in said image, each set of intermediate pixel data values being related to values of said position signal at different times during said pixel time period corresponding to that image pixel value.

11. The scanning probe microscope of claim 10 wherein said data file further comprises a plurality of time stamps, each time stamp being indicative of a time during which said intermediate pixel values utilized to generate a corresponding one of said image pixels was generated.

12. The scanning probe microscope of claim 10 wherein one of said sets of intermediate pixel data values further comprises a value that is not determined by said position signal during said corresponding pixel time period.

13. A method of operating a scanning probe microscope, said method comprising:
providing a probe mount adapted to receive a probe having a tip that moves in response to an interaction between said tip and a local characteristic of a sample, said probe tip being coupled to said probe mount;
generating a position signal indicative of a position of said probe tip;
deriving a first pixel value for a corresponding first location on said sample from said position signal over a first pixel time period, and
storing a plurality of intermediate pixel data values related to values of said position signal at different times during said first pixel time period.

14. The method of claim 13 further comprising generating a second pixel value for a corresponding second location on said sample from said position signal over a second pixel time period,
generating an image of said sample, said image comprising said first and second pixel values; and
storing a plurality of intermediate pixel data values related to values of said position signal at different times during said second pixel time period.

15. The method of claim 13 further comprising storing a time stamp indicative of a time during said first pixel time period associated with said plurality of intermediate pixel data values.

16. The method of claim 15 wherein said time stamp is derived from a clock that is synchronized with an external device separate from said scanning probe microscope, said external device interacting with said sample and providing data relative to said sample, said data including a time stamp that is derived from said clock.

17. The method of claim 13 further generating a servo signal that is input to an electro-mechanical actuator that sets a distance between said second end of said cantilever arm and said sample, and wherein said plurality of intermediate pixel data values comprises values of said servo signal during said first pixel time period.

18. The method of claim 13 further comprising outputting a data file comprising an image of said sample, said image comprising a plurality of image pixel values, each image pixel value being derived from said position signal over a corresponding pixel time period and corresponding to a different location on said sample, said data file further comprising one set of intermediate pixel data values corresponding to each image pixel value in said image, each set of intermediate pixel data values being related to values of said position signal at different times during said pixel time period corresponding to that image pixel value.

19. The method of claim 18 wherein said data file further comprises a plurality of time stamps, each time stamp being indicative of a time during which said intermediate pixel values utilized to generate a corresponding one of said image pixels was generated.

20. The method of claim 18 wherein one of said sets of intermediate pixel data values further comprises a value that is not determined by said position signal during said corresponding pixel time period
